(19) United States
(12) Patent Application Publication
(10) Pub. No.: US 2025/0018497 A1
(43) Pub. Date: Jan. 16, 2025

(54) SYSTEM AND METHOD FOR SEALING A TUBE OF A HOT ISOSTATIC PRESSING (HIP) CANISTER

(71) Applicant: GRAVITAS TECHNOLOGIES PTY LTD, Coniston, New South Wales (AU)

(72) Inventors: Salvatore MORICCA, Woonona, New South Wales (AU); Mitchell CIAGLIA, Dapto, New South Wales (AU)

(21) Appl. No.: 18/711,198

(22) PCT Filed: Nov. 14, 2022
(86) PCT No.: PCT/AU2022/051357

§ 371 Date: May 17, 2024

(30) Foreign Application Priority Data
Nov. 26, 2021 (AU) 2021903820

(51) Int. Cl. B23K 20/02; B21D 39/04; B23K 101/04

(52) U.S. Cl. CPC B23K 20/023; B21D 39/048; B23K 2101/04

(57) ABSTRACT

A system and method for sealing a tube of a hot isostatic pressing (HIP) canister is provided. The system includes an induction heater configured to heat a portion of the tube to a predetermined temperature; and a crimper configured to plastically deform the portion of the tube heated by the induction coil element such that inner surfaces of the portion of the tube are welded together. The method includes heating, by induction, a portion of the tube to a predetermined temperature; and plastically deforming the portion of the tube after being heated such that inner surfaces of the portion of the tube are welded together.

### CROSS-REFERENCE TO RELATED APPLICATIONS

This application is a national stage of PCT Application No. PCT/AU2022/051357, having a filing date of Nov. 14, 2022, which is based AU Application No. 2021903820, having a filing date of Nov. 26, 2021, the entire contents both of which are hereby incorporated by reference.

### FIELD OF TECHNOLOGY

The following relates to a system and method for sealing a tube of a hot isostatic pressing (HIP) canister.

### BACKGROUND

Hot isostatic pressing (HIP) is a process where pressure and heat are applied simultaneously to materials to cause either a change of state or properties. Typically, during the HIP process, a metal canister (which is often referred to as a HIP canister) filled with material is deformed by pressure and heated such that the material therein is compressed and fused together.

In one application, the HIP process is used to turn powdered material (e.g., polymeric, metallic, or ceramic powders) into solid materials and components. Prior to this HIP process, the HIP canister is filled with the powdered material. After filling the HIP canister, any gas in the HIP canister is evacuated through its tube and then the tube is sealed to start the HIP process. The sealing of the tube prevents any gas from re-entering the HIP canister and maintains a pressure differential during the HIP process.

In order to seal the tube of the HIP canister, the tube is typically mechanically crimped and/or folded at one or more positions along the tube and then the end of the tube is welded by a fusion welding process, typically tungsten inert gas (TIG) welding or metal inert gas (MIG) welding. However, there is a risk in this sealing process that gas may re-enter the HIP canister if the crimp is not sufficient or released prior to fusion welding the end of the tube. Further, the length of the tube must be sufficiently long to accommodate multiple crimps and/or folds. Further, the fusion welding process requires the use of an ignition source or flame, which presents a safety risk. Furthermore, the sealing process must be manually carried out by one or more persons and cannot be conducted remotely. This problem is exacerbated when the powdered material is radioactive and it is not safe for persons to be in close proximity to the radioactive material.

### SUMMARY

An aspect relates to a system for sealing a tube of a hot isostatic pressing (HIP) canister, the system comprising: an induction heater configured to heat a portion of the tube to a predetermined temperature; and a crimper configured to plastically deform the portion of the tube heated by the induction coil element such that inner surfaces of the portion of the tube are welded together.

In embodiments, the system may further comprise a carriage configured to hold the HIP canister and move between a heating position in which the induction heater is able to heat the portion of the tube and a crimping position in which the crimper is able to plastically deform the portion of the tube.

The carriage may move linearly between the heating position and the crimping position.

The induction heater may comprise a coil element that defines an induction area for laterally receiving the portion of the tube.

The crimper may comprise first and second jaws movable with respect to each other between an open position to receive the portion of the tube therebetween and a closed position to plastically deform the portion of the tube received by the first and second jaws.

The first jaw may comprise a first part of a die set, and the second jaw comprises a second part of the die set, and the first part may comprise a protrusion and the second part comprises a corresponding recess.

The coil element, the first and second jaws, and the carriage may be disposed in a work area.

In embodiments, the system may further comprise a door configured to move from an open position to provide access to the work area and a closed position to substantially cover the work area.

In embodiments, the system may further comprise a locking mechanism configured to selectively secure the door in the closed position.

The door may comprise an elongate slot for the tube to extend therethrough and move laterally there along.

In embodiments, the system may further comprise a control system configured to:
cause the carriage to move to the heating position;
activate the induction heater;
cause the carriage to move to the crimping position based on the temperature of the portion of the tube; and
activate the crimper.

The control system may be further configured to:
prior to causing the carriage to move to the heating position, cause the locking mechanism to secure the door in the closed position; and
after activating the crimper, cause the locking mechanism to release the door and allow the door to move to the open position based on the temperature of the portion of the tube.

In embodiments, the system may further comprise a cutting mechanism configured to cut the tube above the portion of the tube.

According to another aspect of the present disclosure, there is provided a method for sealing a tube of a hot isostatic pressing (HIP) canister, the method comprising:
heating, by induction, a portion of the tube to a predetermined temperature; and
plastically deforming the portion of the tube after being heated such that inner surfaces of the portion of the tube are welded together.

In embodiments, the method may further comprise cutting the tube upward of the portion of the tube.

### BRIEF DESCRIPTION

Some of the embodiments will be described in detail, with references to the following Figures, wherein like designations denote like members, wherein:

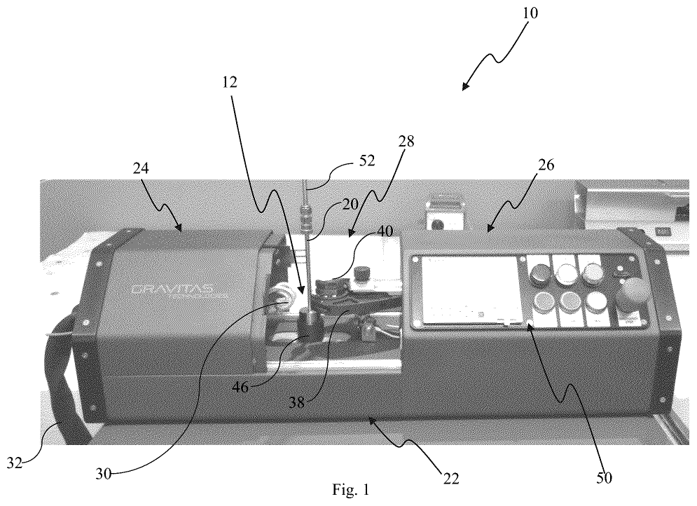

FIG. 1 shows a photograph of an embodiment of a system for sealing a tube of a hot isostatic pressing (HIP) canister;

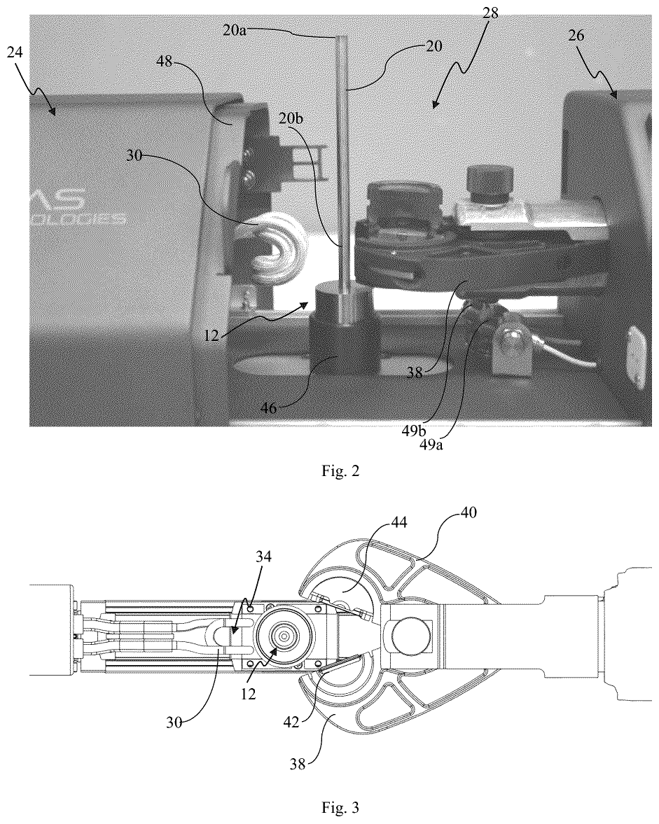

FIG. 2 shows a photograph of a work area of the system of FIG. 1 with a carriage of the system in a loading position;

FIG. 3 shows a top view of the work area of FIG. 2;

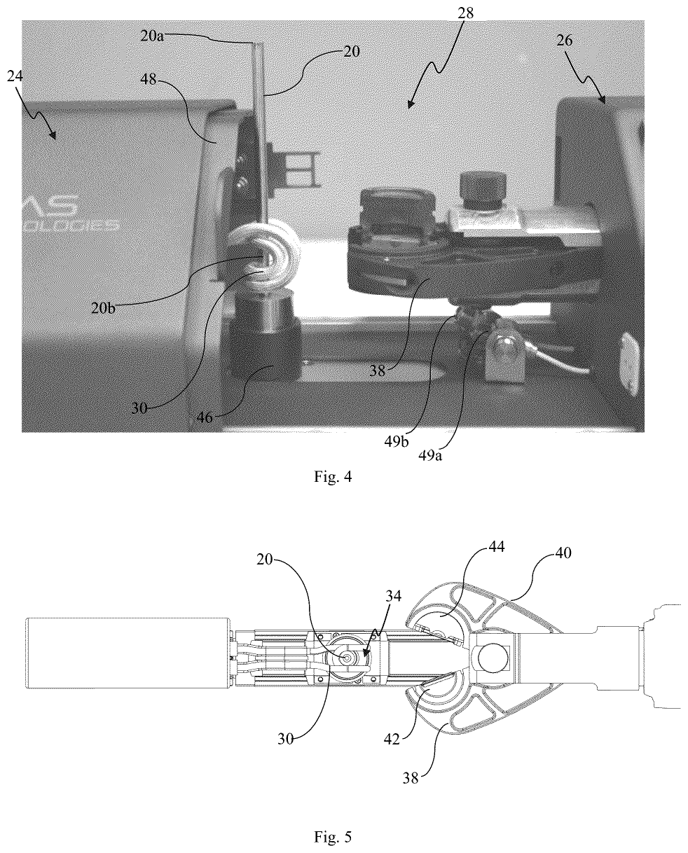

FIG. 4 shows a photograph of the work area of the system of FIG. 1 with the carriage of the system in a heating position;

FIG. 5 shows a top view of the work area of FIG. 4;

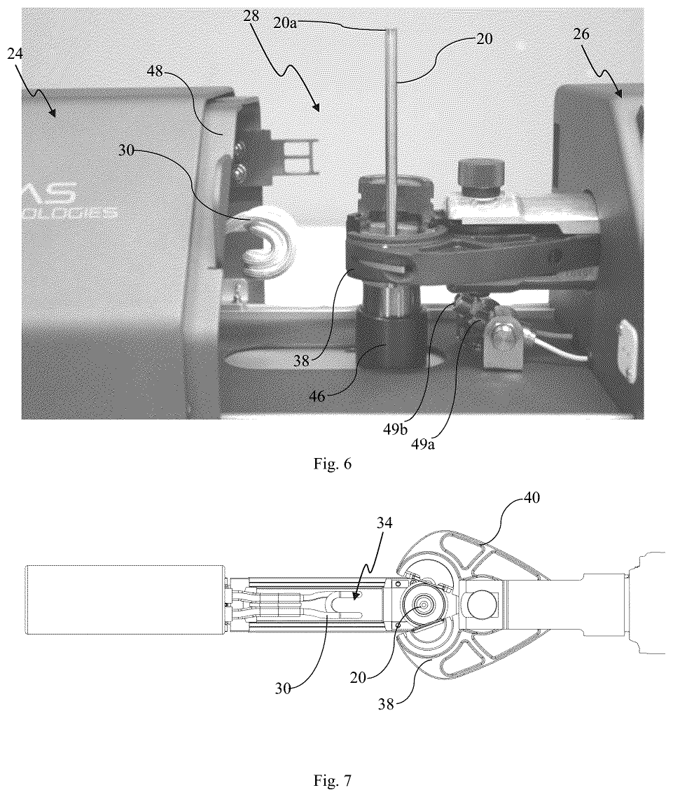

FIG. 6 shows a photograph of the work area of the system of FIG. 1 with the carriage of the system in a crimping position;

FIG. 7 shows a top view of the work area of FIG. 6;

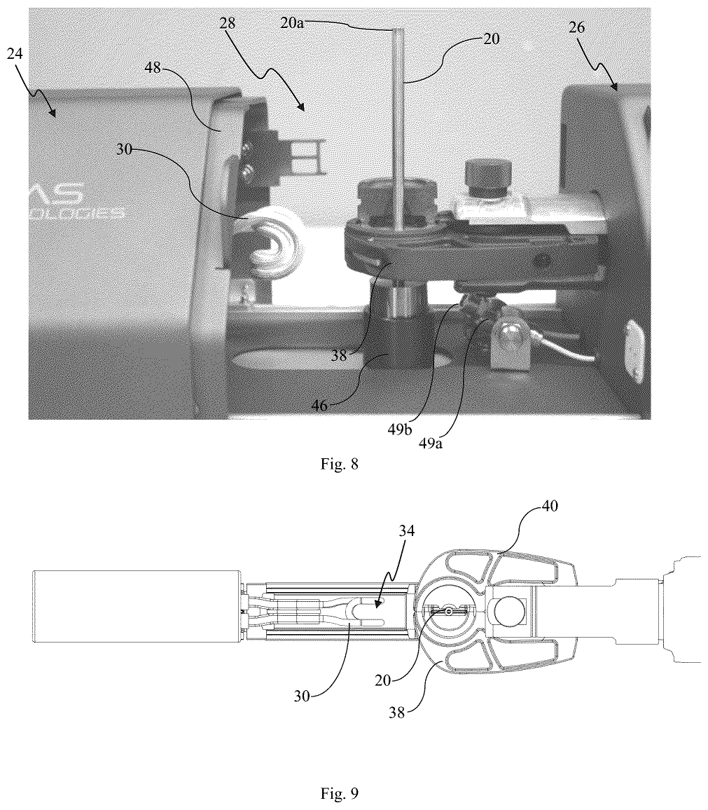

FIG. 8 shows a photograph of the work area of the system of FIG. 1 while a portion of the tube of the HIP canister is being crimped;

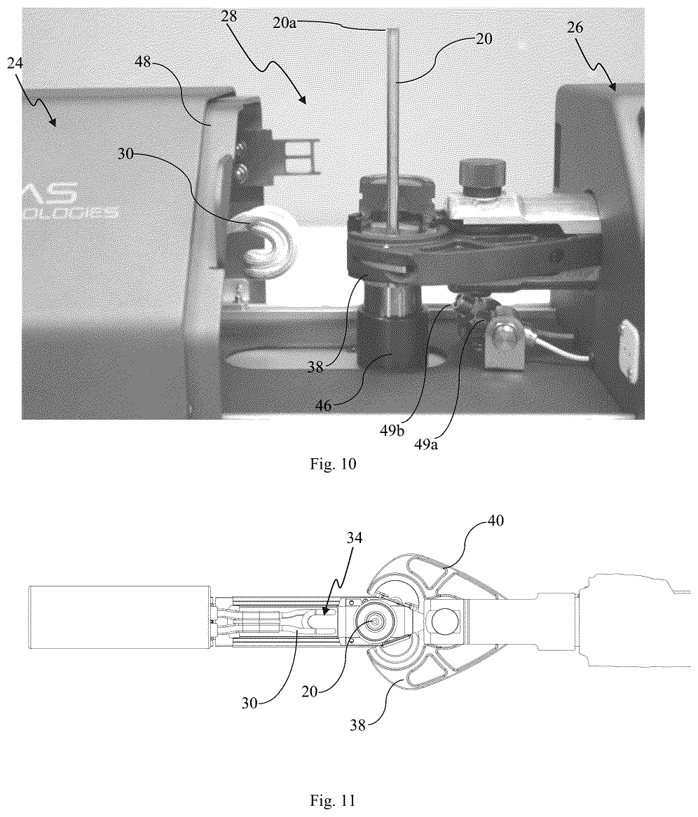

FIG. 9 shows a top view of the work area of the system of FIG. 8;

FIG. 10 shows a photograph of the work area of the system of FIG. 1 with the carriage of the system in a cooling position;

FIG. 11 shows a top view of the work area of the system of FIG. 10;

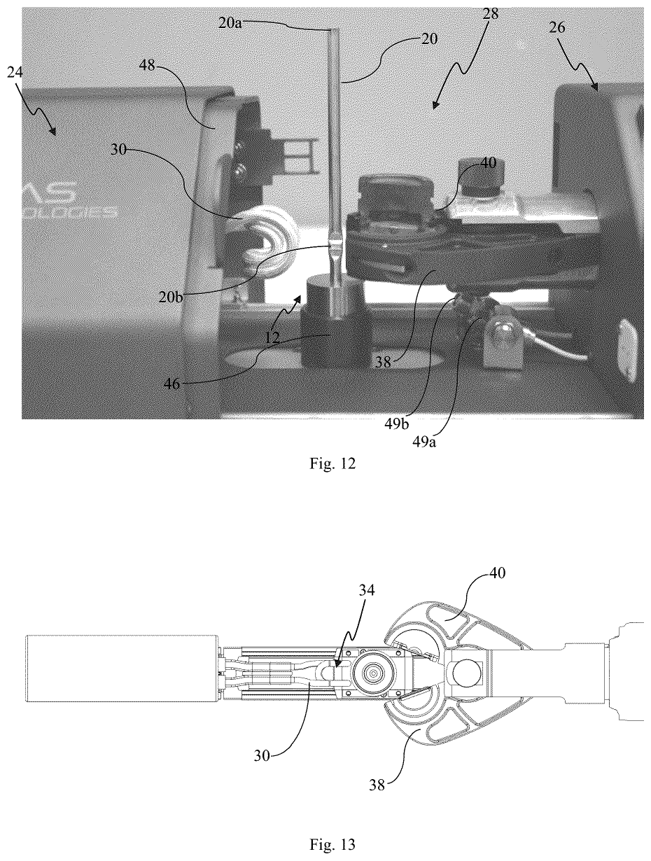

FIG. 12 shows a photograph of the work area of the system of FIG. 1 with the carriage of the system in an unloading position;

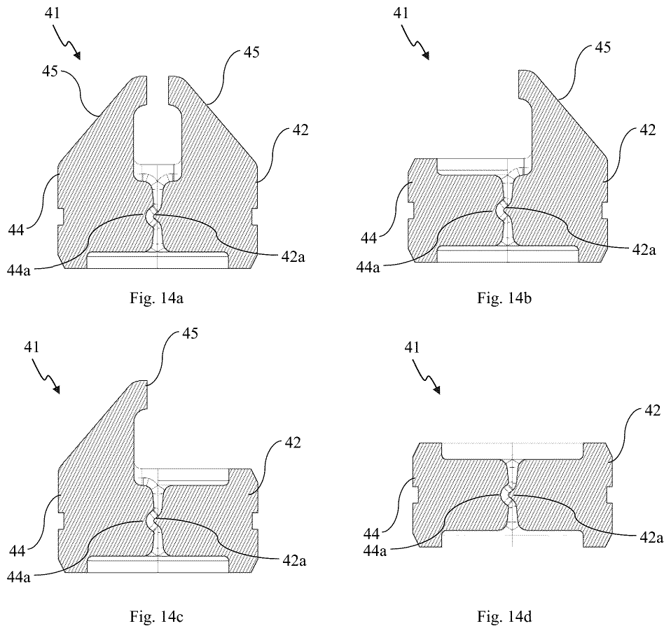

FIG. 13 shows a top view of the work area of the system of FIG. 12;

FIG. 14a shows a sectional view of various embodiments of a die set of a crimper of the system of FIG. 1;

FIG. 14b shows a sectional view of various embodiments of a die set of a crimper of the system of FIG. 1;

FIG. 14c shows a sectional view of various embodiments of a die set of a crimper of the system of FIG. 1;

FIG. 14d shows a sectional view of various embodiments of a die set of a crimper of the system of FIG. 1;

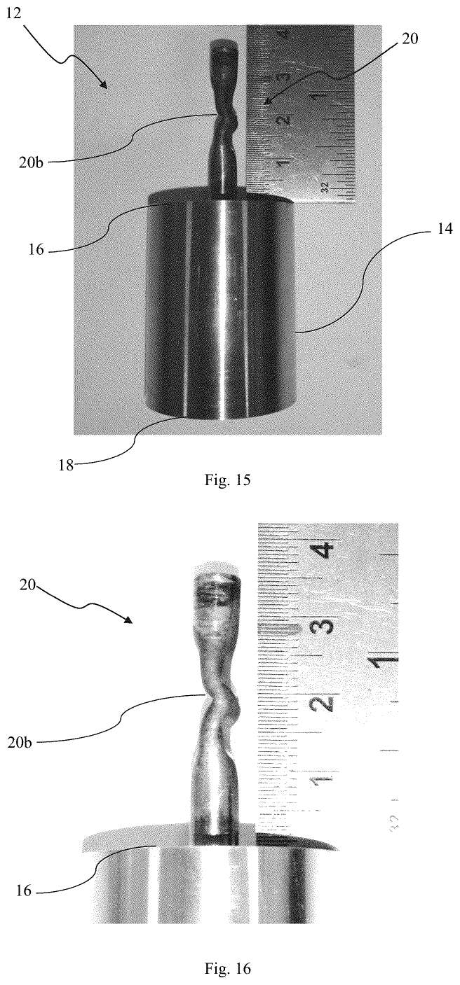

FIG. 15 shows a photograph of the HIP canister after the tube has been sealed and cut; and

FIG. 16 shows an enlarged photograph of the HIP canister of FIG. 15.

### DETAILED DESCRIPTION

FIGS. 1 to 13 show an embodiment of a system 10 for sealing a tube of a hot isostatic pressing (HIP) canister 12. In this embodiment, as best shown in FIG. 15, the HIP canister 12 comprises a cylindrical wall 14 extending between two end plates 16, 18 to define an internal volume, which is filled with radioactive powdered material (e.g., plutonium powder). The HIP canister 12 further comprises an 18/8 austenitic stainless-steel tube 20 that extends upwardly from the end plate 16 to an open free end 20a and provides fluid communication between the open free end 20a and the internal volume so that gas can be evacuated from the internal volume. This tube 20 is often referred to as an “evacuation” tube.

Whilst in this embodiment the HIP canister 12 contains radioactive powdered material, in other embodiments, the HIP canister 12 may be used to contain any other material to undergo the HIP process.

In embodiments, the system 10 comprises a housing 22 having two opposing side portions 24, 26 that define an open work area 28 therebetween. In embodiments, the system 10 further comprises an induction heater having a coil element 30 extending from the side portion 24 into the work area 28 and a power supply (not shown) that electrifies the coil element 30 upon activation. In this embodiment, the power supply is located outside the housing 22 and is electrically connected to the coil element 30 via a cable 32. In other embodiments, however, the power supply may be disposed within housing 22 in the form of a battery, for example.

The coil element 30 is shaped to define an induction area 34 for laterally receiving a portion 20b of the tube 20 such that the tube portion 20b can be heated by induction. In this embodiment, the tube portion 20b is substantially near the end plate 12b.

In embodiments, the system 10 further comprises a crimper configured to plastically deform the tube portion 20b. The crimper comprises first and second jaws 38, 40 that extend from the side portion 26 of the housing 22 into the work area 28 such that the jaws 38, 40 are spaced from the coil element 30. The jaws 38, 40 are actuatable to move with respect to each other between an open position and a closed position. The first jaw 38 comprises a first part 42 of a die set 41 and the second jaw 40 comprises a second part 44 of the die set 41. In this embodiment, the first part 42 has a horizontal ridge protrusion 42a and the second part 44 has a corresponding horizontal recess 44a. In the open position, the first and second jaws 38, 40 are spaced apart to allow the tube portion 20b to be received therebetween as shown in FIGS. 6 and 7. In the closed position, the first and second jaws 38, 40 are adjacent each other such that the horizontal ridge protrusion 42a and the horizontal recess 44a are able to crimp and plastically deform the received tube portion 20b as shown in FIGS. 8 and 9.

In various embodiments, the die set 41 may also include two hoods 45 on respective parts 42, 44 as shown in FIG. 14a, a single hood 45 on the first part 42 as shown in FIG. 14b or a single hood 45 on the second part 44 as shown in FIG. 14c. In another embodiment, the die set 41 may not include any hoods as shown in FIG. 14d.

In other embodiments, rather than the first part 42 having the horizontal ridge protrusion 42a and the second part 44 having the corresponding horizontal recess 44a, the die set 41 may be of any form to be able to crimp and plastically deform the received tube portion 20b. For example, the first part 42 and the second part 44 may both have flat surfaces that engage the received tube portion 20b, the first part 42 and the second part 44 may both have protrusions that engage the received tube portion 20b, and the first part 42 and the second part 44 may both have recesses that engage the received tube portion 20b.

In embodiments, the system 10 further comprises a carriage 46 located in the work area 28 downward of the coil element 30 and the jaws 38, 40. The carriage 46 is configured to hold the HIP canister 12 such that the end plate 18 abuts the carriage 12 and the tube 20 is substantially upright. The carriage 46 is further configured to move to various positions between the side portions 24, 26 of the housing 22 along a linear track to transport the HIP canister 12. In this embodiment, a variable speed, variable force linear actuator (not shown) is used to move the carriage 46 between the various positions upon activation. As shown in FIGS. 2 and 3, in a loading position, the carriage 46 is between the coil element 30 and the jaws 38, 40 such that the HIP canister 12 can be loaded onto the carriage 46. As shown in FIGS. 4 and 5, in a heating position, the carriage 46 is substantially underneath the induction area 34 of the coil element 30 such that the tube portion 20b can be laterally received into the induction area 34. In a crimping position, the carriage 46 is substantially underneath the jaws 38, 40 such that the tube portion 20b can be received by the jaws 38, 40 in the open position as shown in FIGS. 6 and 7 and crimped by the jaws 38, 40 in the closed position as shown in FIGS. 8 and 9. As shown in FIGS. 10 and 11, in a cooling position, the carriage 24 is substantially underneath the jaws 38, 40 like the crimping position. As shown in FIGS. 12 and 13, in an unloading position, the carriage 46 is between the coil element 30 and the jaws 38, 40 such that the carriage 46 is able to be unloaded/removed from the carriage 46.

In embodiments, the system 10 further comprises a door 48 that is slidably attached to the side portion 24 of the housing such that the door 48 is able to move from an open position in which the door 48 is substantially within the side portion 24 to allow access to the work area 28 (for example, for loading the HIP canister onto the carriage 46) and a closed position in which the door 48 substantially covers the work area 28. In this embodiment, the door 48 comprises an elongate upper slot such that the upright tube 20 is able to extend therethrough and not be obstructed by the door 48 when moving laterally as the carriage 46 moves to the various positions. In embodiments, the system 10 further comprises a locking mechanism (not shown) that is disposed in the side portion 26 and is able to lock the door 48 in the closed position upon activation.

In embodiments, the system 10 further comprises a pair of temperature sensors 49a, 49b located near the side portion 26. The first temperature sensor 49a is configured to measure the tube portion 20b when received in the induction area 34 of the coil element 30. The second temperature sensor 49b is configured to measure the tube portion 20b when received by the jaws 38, 40. In this embodiment, the temperature sensors 49a, 49b are optical pyrometers. In other embodiments, the temperature sensors may be thermocouples.

In embodiments, the system 10 further comprises a control system (not shown) in the form of a programmable logic controller (PLC). The PLC is configured to automatically activate, actuate and/or receive indications from specific components of the system 10, such as those described above, in order to seal the tube 20 of the HIP canister 12. It will be appreciated that the PLC may be operated to manually activate and actuate specific components of the system 10 by using the PLC interface 50 located on the side portion 26 of the housing 22. In an embodiment, the system 10 may omit a control system. Instead, the components of the system 10, such as those described above, could be activated and actuated in a manual manner.

A typical automatic operation of the PLC will now be described. In this typical operation, it will be appreciated that the HIP canister 12 has already been filled with radioactive powdered material. Also, the open free end 20a of the tube 20 is connected to a flexible evacuation line 52 to continuously remove any gas within the internal volume of the HIP canister 12. Also, the HIP canister 12 is already loaded onto the carriage 46 which is in the loading position with the door 48 and jaws 38, 40 in the open positions as shown in FIGS. 1 and 2.

Initially, after the door 48 is manually moved to the closed position, the PLC activates the locking mechanism to lock the door 48 in the closed position. This prevents a person from touching components in the work area 28 during the operation of the system 10. It will be appreciated that in FIGS. 4, 6, 8, 10 and 12 the door 48 has been deliberately kept in the open position to show the work area 28 and the components therein during use. However, the door 48 would typically be in the closed position in those figures.

The PLC then activates the linear actuator to move the carriage 46 to the heating position as shown in FIGS. 4 and 5. Accordingly, as the upright tube 20 moves laterally to the coil element 30, the tube portion 20b will be received into the induction area 34 of the coil element 30. The PLC then activates the power supply to electrify the coil element 30 to heat the tube portion 20b to a predetermined temperature for a predetermined amount of time. It will be appreciated that the temperature of the tube portion 20b would be measured by the first temperature sensor 49a, which would feed such measurements to the PLC in order to determine whether the predetermined temperature has been reached. It will also be appreciated that the predetermined temperature and predetermined amount of time would be dependent on the material of the tube 20 for optimum heating and efficiency to allow for a forge weld to be formed.

When the predetermined temperature is reached and maintained for the predetermined amount of time, the PLC activates the linear actuator to move the carriage 46 to the crimping position as shown in FIGS. 6 and 7. As the jaws 38, 40 are in the open position, the heated tube portion 20b is received between the jaws 38, 40. As shown in FIGS. 8 and 9, the PLC then actuates the jaws 38, 40 to move to the closed position such that the heated tube portion 20b is crimped and plastically deformed by the die set 41 such that inner surface within the tube portion 20b are forge welded together. This forms a hermetic seal in the tube portion 20b and thereby hermetically seals the internal volume of the HIP canister 12.

As shown in FIGS. 10 and 11, the PLC then actuates the jaws 38, 40 to the open position and the carriage 46 remains still in the cooling position. Given that the HIP canister 12 is underneath the jaws 38, 40, any attempt to lift the HIP canister 12 by the tube 20 will be substantially prevented by the jaws 38, 40.

The temperature of the tube portion 20b is then measured by the second temperature sensor 49b until the PLC determines that the temperature is at a predetermined safe level so as not to cause any burns to a person or burn any materials that may come into contact with the tube portion 20b (e.g., a glove). Once it is determined that the temperature of the tube portion 20b is at a safe level, the PLC activates the linear actuator to move the carriage 46 to the unloading position as shown in FIGS. 12 and 13. Additionally, the PLC activates the locking mechanism to release the lock on the door 48 so that the door 48 can be manually opened and the HIP canister 12 can be removed/unloaded from the carriage 46.

After the system has completed its operation, the tube 20 is manually cut above the sealed tube portion 20b as shown in FIGS. 15 and 16, and the HIP canister 12 can then undergo the HIP process. In an embodiment, the system 10 may further comprise one or more blades on the jaws 38, 40 such that the tube 20 would be cut simultaneously as it is crimped and welded. Alternatively, in embodiments the system 10 may further comprise a cutting mechanism configured to cut the tube 20 after the tube portion 20b has been crimped and welded.

According to the an embodiment, the system 10 crimps and seals the tube 20 at the same time and thereby reduces the risk of gas from re-entering the HIP canister 12. Further, in embodiments the system 10 does not require the use of an ignition source or flame to weld the tube 20, which reduces safety risk. Further, there is no need for skilled welders to complete the seal of the HIP canister 12. Further, in embodiments the system 10 is substantially autonomous and thus does not require a person to be in close proximity or engage in manual actions to crimp, bend and/or weld the tube 20 during the sealing process. Further, in embodiments the system 10 allows the tube 20 to be cut relatively close to the end plate 16 (i.e., less than 50 mm) without numerous bends in the tube 20 such that the length of the cut tube 20 can be minimised. Further, the use of the induction heater also allows for efficient heating of only a localised area of the tube 20 without producing excessive heat.

In an embodiment, the HIP canister 12 remains stationary during the operation of the system 10. Specifically, rather than having a carriage 46 move the HIP canister 12, the coil element 30 and the jaws 38, 40 are automatically or manually moved to the stationary HIP canister 12 to heat and crimp the tube portion 20b. This is particularly useful when it is not practical or difficult to move the HIP canister 12 due to its weight and size. In such an embodiment, the coil element 30 and the jaws 38, 40 may also be arranged such that the linear movement of the coil element 30 is angled in relation to the linear movement of the jaws 38, 40. For example, the linear movement of the coil element 30 towards the tube portion 20b may be perpendicular to the linear movement of the jaws 38, 40 towards the tube portion 20b.

In an embodiment, the coil element 30 is arranged below or above the jaws 38, 40 and the carriage 46 is configured to move the HIP canister 12 upwardly or downwardly between the various positions during the operation of the system 10. Alternatively, in an embodiment, the HIP canister 12 remains stationary and the coil element 30 and the jaws 38, 40 are either automatically or manually moved upwardly or downwardly to the stationary HIP canister 12 to heat and crimp the tube portion 20b.

In an embodiment, the system 10 may be in the form of a portable device that can be manually manipulated and moved by a user so that its components can engage the tube of a stationary HIP canister and seal the same.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A system for sealing a tube of a hot isostatic pressing 4 canister, the system comprising:
an induction heater configured to heat a portion of the tube to a predetermined temperature; and
a crimper configured to plastically deform the portion of the tube heated by the induction coil element such that inner surfaces of the portion of the tube are welded together.

2. The system of claim 1, further comprising a carriage configured to hold the HIP canister and move between a heating position in which the induction heater is able to heat the portion of the tube and a crimping position in which the crimper is able to plastically deform the portion of the tube.

3. The system of claim 2, wherein the carriage moves linearly between the heating position and the crimping position.

4. The system of claim 1, wherein the induction heater comprises a coil element that defines an induction area for laterally receiving the portion of the tube.

5. The system of claim 1, wherein the crimper comprises first and second jaws movable with respect to each other between an open position to receive the portion of the tube therebetween and a closed position to plastically deform the portion of the tube received by the first and second jaws.

6. The system of claim 5, wherein the first jaw comprises a first part of a die set and the second jaw comprises a second part of the die set, and wherein the first part comprises a protrusion and the second part comprises a corresponding recess.

7. The system of claim 5, wherein the coil element, the first and second jaws, and the carriage are disposed in a work area.

8. The system of claim 7, further comprising a door configured to move from an open position to provide access to the work area and a closed position to substantially cover the work area.

9. The system of claim 8, further comprising a locking mechanism configured to selectively secure the door in the closed position.

10. The system of claim 8, wherein the door comprises an elongate slot for the tube to extend therethrough and move laterally there along.

11. The system of claim 2, further comprising a control system configured to:
cause the carriage to move to the heating position;
activate the induction heater;
cause the carriage to move to the crimping position based on the temperature of the portion of the tube; and
activate the crimper.

12. The system of claim 10, wherein the control system is further configured to:
prior to causing the carriage to move to the heating position, cause the locking mechanism to secure the door in the closed position; and
after activating the crimper, cause the locking mechanism to release the door and allow the door to move to the open position based on the temperature of the portion of the tube.

13. The system of claim 1, further comprising a cutting mechanism configured to cut the tube above the portion of the tube.

14. A method for sealing a tube of a hot isostatic pressing canister, the method comprising:
heating, by induction, a portion of the tube to a predetermined temperature; and
plastically deforming the portion of the tube after being heated such that inner surfaces of the portion of the tube are welded together.

15. The method of claim 13, further comprising cutting the tube upward of the portion of the tube.
